(19) United States
(12) Patent Application Publication
(10) Pub. No.: US 2008/0274697 A1
(43) Pub. Date: Nov. 6, 2008

(54) Radio communication apparatus

(76) Inventor: Osamu Ito, Tokyo (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(21) Appl. No.: 11/973,699

(22) Filed: Oct. 10, 2007

(30) Foreign Application Priority Data
Oct. 19, 2006 (JP) 2006-285535

(51) Int. Cl. H04B 1/00

(52) U.S. Cl. 455/42

(57) ABSTRACT

Disclosed here in is a radio communication apparatus for transmitting a modulated reflected wave signal to a reflected wave reading apparatus as a signal resulting from a modulation process to modulate an unmodulated carrier, which is received from the reflected wave reading apparatus, in order to superpose information to be transmitted to the reflected wave reading apparatus on the unmodulated carrier, the radio communication apparatus including: an antenna; information outputting means configured to generate information to be transmitted to the reflected wave reading apparatus; feed characteristic changing means configured to change a feed characteristic of the antenna in accordance with the information to be transmitted; radiation characteristic changing means configured to change a radiation characteristic of the antenna in accordance with the information to be transmitted; and modulation means configured to carry out the modulation process according to the information to be transmitted in a process to reflect an electric wave signal received by the antenna.

### CROSS REFERENCES TO RELATED APPLICATIONS

The present invention contains subject matter related to Japanese Patent Application JP 2006-285535 filed with the Japan Patent Office on Oct. 19, 2006, the entire contents of which being incorporated herein by reference.

### BACKGROUND OF THE INVENTION

1. Field of the Invention

The present invention relates to a radio communication apparatus for implementing communication operations at a low power consumption between pieces of equipment separated from each other by a short distance. More particularly, the present invention relates to a radio communication apparatus for transmitting a modulated reflected signal obtained as a result of a process to modulate an unmodulated carrier received from a reflected wave reading apparatus.

To put it in more detail, the present invention relates to a radio communication apparatus for transmitting a modulated reflected wave signal with an increased information amount per symbol signal. More particularly, the present invention relates to a radio communication apparatus for raising a communication speed and improving a communication quality by making use of a simple circuit for applying a QAM method and or an OFDM method to reflected wave transmissions.

2. Description of the Related Art

A radio communication technology is expected for a system technology for enabling the user to get rid of wiring cables used in the wire communication system and has been becoming popular at a very high pace. Radio communications to which the radio communication technology is applied include communications making use of hand phones such as PDCs (Personal Digital Cellular phones) and PHSes (Personal Handyphone Systems) as well as LAN (Local Area Network) and Bluetooth communications represented by communications conforming to the IEEE802.11.

In addition, there has been recently proposed a data communication system making use of a non contact communication method adopted in an RFID (Radio Frequency Identifier) among others. Examples of the non contact communication method are an electrostatic junction method, an electro magnetic induction method and a wave communication method. A system adopting the wave communication method employs:

a reflected wave transmission apparatus for transmitting data by including the data in a reflected wave signal in a process carried out to modulate a unmodulated carrier received from a reflected wave reading apparatus; and

the reflected wave reading apparatus for reading out the data from the wave signal modulated and reflected by the reflected wave transmission apparatus. The system is thus a system for carrying out reflected wave transmissions known as a backscatter.

When the reflected wave transmission apparatus receives an unmodulated carrier from the reflected wave reading apparatus, the reflected wave transmission apparatus modulates the carrier serving as a wave signal to be reflected by carrying out an operation to change the load impedance of an antenna in order to superpose data to be transmitted on the wave signal. Since the reflected wave transmission apparatus does not require a source for generating a carrier by itself, the reflected wave transmission apparatus can be driven to carry out an operation to transmit data at a small power consumption. In general, an antenna switch for changing the load impedance of the antenna is an IC (Integrated Circuit) made of GaAs (Gallium Arsenic) having a power consumption not exceeding several tens of μW. By the way, a radio LAN consumes a power electric ranging from several hundreds of mW to several W in a process to carry out a communication. Thus, in comparison with the average power consumption of communications making use of an ordinary radio LAN, the reflected wave communication can be said to be communication having an overwhelming difference in power consumption from the communication making use of an ordinary radio LAN. (For example, refer to as Japanese Patent Laid-open No. 2005-64822, referred to as Patent Document 1 hereinafter.)

In an ordinary communication system, the communication apparatus existing on both sides as partners communicating with each other each generate a wave signal in order to transmit information to the communication partner. In a communication system making use of reflected wave transmissions, on the other hand, a terminal employing a reflected wave transmission apparatus merely carries out an operation to reflect a received wave signal. Thus, the terminal is not regarded as a radio station. As a result, the terminal is exempted from the law regulating wave communications. In addition, non contact communication systems adopting the electro magnetic induction method and other methods each make use of a frequency ranging from several MHz to several hundreds of MHz. With the reflected wave communication method, on the other hand, it is possible to implement a high speed data transmission making use of a 2.4 GHz high frequency band referred to as an ISM (Industry Science and Medical Band).

For example, the reflected wave transmission apparatus is used as a terminal incorporated in a mobile system to have a small power consumption whereas the reflected wave reading apparatus is incorporated in host equipment such as an electric household appliance installed at a home. An example of the mobile system is a system employing a digital camera, a video camera, a hand phone, a portable information terminal or a portable music reproduction apparatus. On the other hand, examples of the electric household appliance are a TV, a monitor, a printer, a PC, a VTR and a DVD player. Then, a picture taken by the hand phone employing an embedded camera or the digital camera can be uploaded to the PC through a reflected wave transmission line to be stored, displayed and or printed out by the PC.

FIG. 8 is a block diagram showing a typical configuration of a radio communication system adopting a reflected wave transmission method according to the existing technology. In the figure, reference numeral 500 denotes a radio transmission apparatus employed in mobile equipment including a reflected wave transmission apparatus. Reference numeral 510 denotes a radio transmitter receiver employed in the reflected wave reading apparatus. The radio transmission apparatus 500 transmits data to the radio transmitter receiver 510 by adoption of the reflected wave transmission method. The radio transmission apparatus 500 is connected to an application section 503 such as a digital camera. By the same token, the radio transmitter receiver 510 is connected to an application section 519 such as a printer.

In the radio transmitter receiver 510, a BB (Base Band) processing section 518 turns on a transmission section 517 for transmitting an unmodulated carrier generated by a local oscillator 513 at a frequency fo to the radio transmission apparatus 500 by way of a circulator 512 and an antenna 511. The unmodulated carrier generated by the local oscillator 513 at the frequency fo is received by an antenna 501 employed in the radio transmission apparatus 500.

The antenna 501 employed in the radio transmission apparatus 500 receives the unmodulated carrier having the frequency fo. In addition to the antenna 501, the radio transmission apparatus 500 also employs a reflected wave modulator 502. The reflected wave modulator 502 is a section for modulating the carrier in order to include data received from the application section 503. The modulation process carried out by the reflected wave modulator 502 is a QPSK (Quadrature Phase Shift Keying), PSK (Phase Shift Keying) or ASK (Amplitude Shift Keying) modulation process for the backscatter transmission of a reflected wave signal. The backscatter modulation process can be carried out with ease in an operation to change the load impedance of the antenna 501 by making use a rectifier circuit employing diodes or by turning on and off an antenna switch implemented by an IC (Integrated Circuit) made of GaAs (Gallium Arsenic).

FIG. 9 is a diagram showing a typical internal configuration of the reflected wave modulator 502 for generating a modulated reflected wave signal by turning an antenna switch 502A on and off. The antenna switch 502A is turned on and off in accordance with the bit image of data to be transmitted. For example, when the data is one bit, the antenna switch 502A is turned on and, when the data is zero bit, on the other hand, the antenna switch 502A is turned off. One of the terminals of the antenna switch 502A is connected to the antenna 501 whereas the other terminal of the antenna switch 502A is connected to the ground by a resistor used as an antenna load 502B having a resistance of 50Ω. Thus, when the antenna switch 502A is turned on, the antenna 501 is terminated by the antenna load 502B. When the antenna switch 502A is turned off, on the other hand, the antenna 501 is open. As a result, the reflected wave modulator 502 transmits a reflected wave signal completing a modulation process carried out by varying the load impedance of the antenna 501 in accordance with the on and off states of the antenna switch 502A. The wave signal modulated by the reflected wave modulator 502 in this way and reflected by the antenna 501 is eventually a signal generated with the frequency fo of the unmodulated carrier taken as a center frequency.

In the radio transmitter receiver 510, on the other hand, the reflected wave signal with the center frequency fo modulated is supplied to a receiving section 514 by way of an antenna 511 and a circulator 512. An orthogonal demodulation section 515 receives the carrier generated by the local oscillator 513 at the frequency fo. By making use of the carrier having the frequency fo, the orthogonal demodulation section 515 carries out a direct conversion reception in order to generate I′ and Q′ components of a base band signal.

An AGC (Automatic Gain Control) amplifier 516 provided at the stage amplifies the I′ and Q′ components of the base band signal to a desired level in order to generate I and Q components of the base band signal. The AGC amplifier 516 supplies the I and Q components of the base band signal to a BB processing section 518. The BB processing section 518 is a section for demodulating the I and Q components of the base band signal and supplying the received data and received clock to the application section 519 along with a signal receiving process frequency.

As described above, the reflected wave modulator 502 employed in the radio transmission apparatus 500 carries out a modulation process by adoption of an ordinary modulation method such as a PSK (Phase Shift Keying), ASK (Amplitude Shift Keying) or FSK (Frequency Shift Keying) method. However, the radio transmitter receiver 510 receiving the wave signal reflected by the radio transmission apparatus 500 does not have to adopt a demodulation method dedicated for the backscatter transmission.

There has been proposed a reflected wave communication system adopting both the ASK and PSK modulation methods as described in documents such as Patent Document 1. In addition, there has also been proposed a technique for configuring a modulation PSK method applied to reflected wave communications as described in documents such as Japanese Patent Laid-open No. 2004-222280 referred to as Patent Document 2 hereinafter. For more information on the configuration technique, the reader is suggested to refer to documents such as Japanese Patent Laid-open No. 2004-357278 and Japanese Patent Laid-open No. 2004-357300 referred to as Patent Documents 3 and 4 hereinafter, respectively.

The ASK, PSK and FSK modulation methods are each a modulation method having no variation components in the amplitude direction. In general, they each have an information amount of one bit per symbol signal. Their data rates are thus not high. If a larger number of phase positions can be created in a phase space, the amount of information per symbol signal can be increased.

In the communication technology field, as a multi value modulation method, there has been known a QAM (Quadrature Amplitude Modulation) method for carrying out a signal mapping process in the amplitude and phase directions. In addition, in accordance with an OFDM (Orthogonal Frequency Division Multiplexing) modulation method for transmitting data by allocating the data to a plurality of sub carriers, which are orthogonal to each other in a symbol space and each have a carrier frequency, the frequency utilization efficiency can be increased and the data transmission can be made less prone to frequency selectivity phasing interferences.

Also in a communication system adopting the reflected wave transmission method, enhancement of the communication speed and improvement of the communication quality are thought to be possible by adoption of the QAM and or OFDM modulation methods. If these QAM and or OFDM modulation methods are applied to a data transmitting receiving apparatus employing the existing reflected wave transmitter and the existing reflected wave receiver, however, the circuit scale will increase, entailing a high level circuit technology. Thus, offering no low power consumption through utilization of an inexpensive circuit, the data transmitting receiving apparatus undesirably loses the original characteristic of the reflected wave transmission method.

### SUMMARY OF THE INVENTION

Addressing the problems described above, inventors of the present invention have innovated an excellent radio communication apparatus capable of well transmitting a reflected wave signal obtained as a result of a process to modulate an unmodulated carrier received from a reflected wave reading apparatus.

The radio communication apparatus is also capable of transmitting the modulated reflected wave signal at a high data rate by increasing the amount of information per symbol signal.

In addition, the radio communication apparatus is capable of increasing the communication speed and improving the communication quality by application of a modulation method such as the QAM and OFDM methods including an amplitude vibration component to the transmission of the reflected wave signal by making use of a simple circuit.

According to an embodiment of the present invention, it is desirable to provide a radio communication apparatus for transmitting a modulated reflected wave signal to a reflected wave reading apparatus as a signal resulting from a modulation process to modulate an unmodulated carrier, which is received from the reflected wave reading apparatus, in order to superpose information to be transmitted to the reflected wave reading apparatus on the unmodulated carrier. The radio communication apparatus includes: an antenna; information outputting means configured to generate information to be transmitted to the reflected wave reading apparatus; and feed characteristic changing means configured to change a feed characteristic of the antenna in accordance with the information to be transmitted. The radio communication apparatus further includes: radiation characteristic changing means configured to change a radiation characteristic of the antenna in accordance with the information to be transmitted; and modulation means configured to carry out the modulation process according to the information to be transmitted in a process to reflect an electric wave signal received by the antenna.

In the following description, the technical term ‘system’ implies the configuration of a confluence including a plurality of apparatus logically connected to each other. In this case, the apparatus may each be interpreted as a functional module for implementing a specific function. The apparatus and/or the functional modules can be logically connected to each other without regard to whether the apparatus and/or the functional modules are put in a single cabinet.

The present invention relates to a reflected wave communication system, which employs a reflected wave transmission apparatus and a reflected wave reading apparatus. The reflected wave transmission apparatus is an apparatus for transmitting a modulated reflected wave signal to the reflected wave reading apparatus as a signal resulting from a process to modulate an unmodulated carrier, which is received from the reflected wave reading apparatus, in order to superpose data to be transmitted to the reflected wave reading apparatus on the carrier. The reflected wave reading apparatus is an apparatus for reading out the data transmitted to the reflected wave reading apparatus from the modulated reflected wave signal received from the reflected wave transmission apparatus. The reflected wave communication system adopts an electric wave reflection technology. In accordance with the communication system of this type, the reflected wave transmission apparatus does not need a carrier generation source. Thus, the reflected wave transmission apparatus is capable of transmitting data to the reflected wave reading apparatus at a substantially reduced power consumption. For this reason, the data transmission according to electric wave reflection technology offers an overwhelming difference in comparison with the ordinary data transmission making use of a radio LAN.

The reflected wave communication system adopts either of the ASK, PSK and FSK modulation methods, which are each a modulation method having no variation components in the amplitude direction. In general, these modulation methods each have an information amount of one bit per symbol signal. The data rates of the modulation methods are thus not high.

Also in the reflected wave transmission, if a larger number of phase positions can be created in a phase space, the amount of information per symbol signal can be increased. In addition, enhancement of the communication speed and improvement of the communication quality are thought to be possible by adoption of the QAM and or OFDM modulation methods. If these QAM and or OFDM modulation methods are applied to the reflected wave communication system, however, the circuit scale increases, entailing a high level circuit technology. Thus, offering no low power consumption with an inexpensive circuit, the reflected wave transmission apparatus employed in the reflected wave communication system undesirably loses the original characteristic of the reflected wave transmission method.

On the other hand, the radio communication apparatus according to an embodiment of the present invention includes feed characteristic changing means configured to change a feed characteristic of an antenna in accordance with information to be transmitted to a reflected wave reading apparatus. The radio communication apparatus further includes: radiation characteristic changing means configured to change a radiation characteristic of the antenna in accordance with the information to be transmitted; and power reflection means configured to reflect a power fed by the antenna in an output wave signal. Thus, by making use of a configuration for changing the feed and radiation characteristics of the antenna in accordance with the information to be transmitted to the reflected wave reading apparatus, the radio communication apparatus is capable of implementing amplitude level variations for generating a QAM signal and or an OFDM signal in the reflected wave signal.

That is to say, in accordance with the present invention, it is possible to assure a good characteristic for modulation methods (such as the QAM and or OFDM methods) having an amplitude change component. Thus, the communication speed can be increased and the communication quality can be improved by making use of a relatively simple circuit.

The feed characteristic changing means is capable of changing the feed characteristic of the antenna by changing either of a directivity and a polarization plane, which each show a characteristic exhibited by the antenna with respect to a wave signal. As an alternative, the radiation characteristic changing means is made capable of changing the radiation characteristic of the antenna by changing the directivity or the polarization plane.

In addition, the feed characteristic changing means is capable of changing the feed characteristic of the antenna by changing either of an impedance and a resonance point, which each show the electrical characteristic of the antenna. As an alternative, the radiation characteristic changing means is made capable of changing the radiation characteristic of the antenna by changing the impedance or the resonance point.

Further, the feed characteristic changing means is capable of changing the feed characteristic of the antenna by changing a polarization wave type showing the characteristic of a wave signal generated by the antenna. As an alternative, the radiation characteristic changing means is made capable of changing the radiation characteristic of the antenna by changing the type of the polarization wave. The type of the polarization wave indicates that the polarization wave signal is a circular signal, which can be a right direction circular signal or a left direction circular signal, an elliptical signal or a straight line signal.

According to an embodiment of the present invention, it is possible to provide an excellent radio communication apparatus capable of transmitting a modulated reflected wave signal by increasing the amount of information per symbol signal.

In addition, in accordance with the present invention, it is possible to provide an excellent radio communication apparatus capable of increasing the communication speed and improving the communication quality through application of modulation methods (such as the QAM and or OFDM methods) having an amplitude variation component to the reflected wave transmission by making use of a simple circuit.

These and other objects and features of the present invention will become clear from the following detailed description of a preferred embodiment given with reference to accompanying diagrams.

### BRIEF DESCRIPTION OF THE DRAWINGS

These and other objects and features of the present invention will become clear from the following description of the preferred embodiments given with reference to the accompanying diagrams, in which:

FIG. 1 is a block diagram showing a model of the configuration of a radio communication system according to an embodiment of the present invention;

FIG. 2A is a diagram showing a directivity pattern exhibited by a receiving antenna for a case in which an angle measured with the direction of an arriving wave signal taken as a reference as an angle corresponding to a largest received power observed by a feed characteristic changing section is selected;

FIG. 2B is a diagram showing a directivity pattern exhibited by a receiving antenna for a case in which an angle measured with the direction of an arriving wave signal taken as a reference as an angle corresponding to a received power attenuated by 10 dB from the largest received power observed by a feed characteristic changing section is selected;

FIG. 3A is a diagram showing a curve representing a relation between changes of a received power and changes of the polarization direction of a receiving antenna for a case in which an angle measured with the polarization direction of an arriving wave signal taken as a reference to represent a largest received power observed by a feed characteristic changing section is selected;

FIG. 3B is a diagram showing a curve representing a relation between changes of a received power and changes of the polarization direction of a receiving antenna for a case in which an angle measured with the polarization direction of an arriving wave signal taken as a reference to represent a received power attenuated by 10 dB from the largest received power observed by a feed characteristic changing section is selected;

FIG. 4 is a diagram showing an output generated by the modulation section on the basis of FIGS. 2A, 2B, 3A, and 3B;

FIG. 5A is a diagram showing typical mapping of bit data for the existing 16QAM method;

FIG. 5B is a diagram showing a relation between mapping points used in the embodiment and the feed characteristic changing section or a radiation characteristic changing section;

FIG. 6 is a diagram showing a typical output of the radiation characteristic changing section or a case in which a null point exists;

FIG. 7 is a diagram showing a typical output of the radiation characteristic changing section or a case in which no null point exists in either the feed characteristic or the radiation characteristic;

FIG. 8 is a block diagram showing a typical configuration of a radio communication system adopting a reflected wave transmission method according to the existing technology; and

FIG. 9 is a diagram showing a typical internal configuration of a reflected wave modulation apparatus for generating a modulated reflected wave signal by turning an antenna switch on and off.

### DETAILED DESCRIPTION OF THE PREFERRED EMBODIMENT

A preferred embodiment of the invention is described in detail by referring to diagrams as follows.

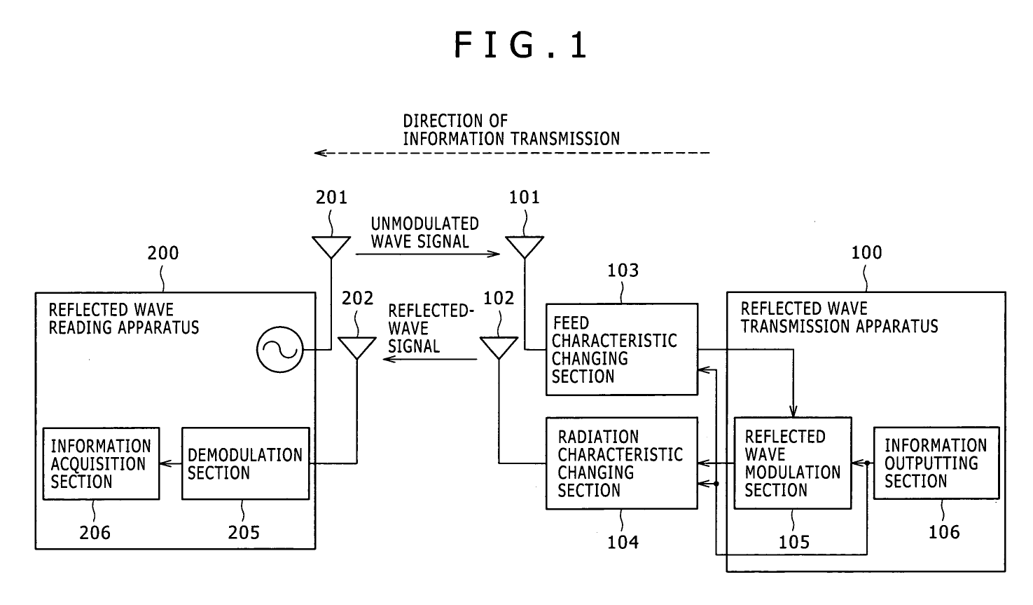

FIG. 1 is a block diagram showing a model of the configuration of a radio communication system according to an embodiment of the present invention. The radio communication system shown in the figure adopts the reflected wave transmission method, employing a reflected wave transmission apparatus 100 and a reflected wave reading apparatus 200. The reflected wave transmission apparatus 100 employs a receiving antenna 101, a transmitting antenna 102, a feed characteristic changing section 103, a radiation characteristic changing section 104, a reflected wave reflected wave modulation section 105 and an information outputting section 106. On the other hand, the reflected wave reading apparatus 200 employs a transmitting antenna 201, a receiving antenna 202, a demodulation section 205, an information acquisition section 206 and an oscillator 207.

In the reflected wave reading apparatus 200, the oscillator 207 generates an unmodulated wave signal with a frequency band as a signal to be used in radio communications. The oscillator 207 supplies the unmodulated wave signal to the transmitting antenna 201.

The unmodulated wave signal radiated by the transmitting antenna 201 is fed to the receiving antenna 101 employed by the reflected wave transmission apparatus 100 and then output from the receiving antenna 101 to the feed characteristic changing section 103.

After the feed characteristic changing section 103 changes the feed characteristic in accordance with a command issued by the information outputting section 106, the feed characteristic changing section 103 supplies the received unmodulated wave signal to the reflected wave modulation section 105.

In accordance with information received from the information outputting section 106, the reflected wave modulation section 105 modulates the unmodulated wave signal received from the feed characteristic changing section 103 at a changed feed characteristic and supplies the modulated wave signal to the radiation characteristic changing section 104.

After the radiation characteristic changing section 104 changes the radiation characteristic of the transmitting antenna 102 in accordance with a command issued by the information outputting section 106, the radiation characteristic changing section 104 supplies the modulated wave signal to the transmitting antenna 102.

The transmitting antenna 102 radiates the modulated wave signal, which is received from the radiation characteristic changing section 104, at a changed radiation characteristic to the reflected wave reading apparatus 200.

In the reflected wave reading apparatus 200, the modulated wave signal transmitted by the transmitting antenna 102 is received by the receiving antenna 202 and fed to the demodulation section 205.

The demodulation section 205 demodulates the modulated wave signal received from the receiving antenna 202 and supplies a wave signal obtained as a result of the demodulation process to the information acquisition section 206. The information acquisition section 206 fetches desired information from the wave signal received from the demodulation section 205.

It is to be noted that, in the configuration shown in FIG. 1 as the configuration of the radio communication system, the reflected wave transmission apparatus 100 employs the receiving antenna 101 for feeding to an unmodulated wave signal and the transmitting antenna 102 for transmitting a modulated wave signal conveying information transmitted to the reflected wave transmission apparatus 100 independently of the receiving antenna 101 in order to make the explanation simple. In such a configuration, the directivity and polarization plane of the receiving antenna 101 can be controlled independently of the directivity and polarization plane of the transmitting antenna 102. It is needless to say, however, the receiving antenna 101 and the transmitting antenna 102 can be integrated to form a single common antenna. In this case, the directivity of the single common antenna is controlled in order to change both the feed and radiation characteristics. By the same token, the polarization plane of the single common antenna is also controlled in order to change both the feed and radiation characteristics. In addition, the feed characteristic changing section 103 and the radiation characteristic changing section 104 can be integrated into a single circuit chip. In the same way, the transmitting antenna 201 and receiving antenna 202 can also be integrated to form a single common antenna for transmitting an unmodulated carrier to the reflected wave transmission apparatus 100 and receiving an a modulated wave signal reflected by the reflected wave transmission apparatus 100.

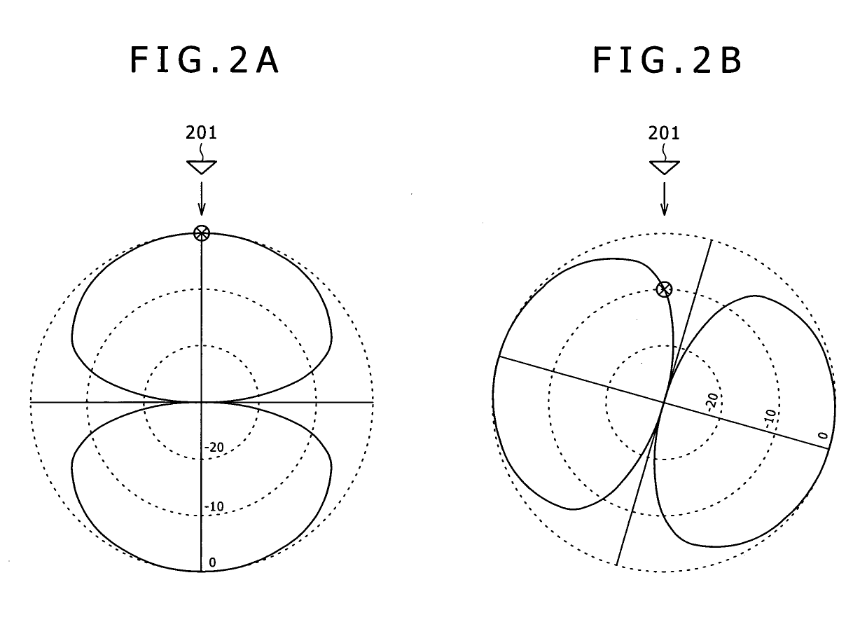

FIGS. 2A and 2B are diagrams each showing a characteristic exhibited by the feed characteristic changing section 103 with respect to the receiving antenna 101. In this diagram, a figure having a circular shape is the directivity pattern of the receiving antenna 101. A scale is set with the largest value of the received power taken as a reference of 0 dB. Concentric circles each drawn by a dashed line each represent an attenuating quantity. Solid lines represent relative values of the received power observed by the feed characteristic changing section 103 with the direction of the arriving wave signal taken as a reference. As is obvious from the characteristics, the longer the radial direction radius, the larger the relative value of the received power. That is to say, the shorter the radial direction radius, the smaller the relative value of the received power. (Strictly speaking, the power of the arriving wave signal itself does not change. Instead, it is the sensitivity that does change.)

In FIGS. 2A and 2B, the wave signal arrives in a downward direction from the upper portion of the figure. The downward direction in FIGS. 2A and 2B is the signal transmitting direction of the transmitting antenna 201 employed in the reflected wave reading apparatus 200 shown in FIG. 1. In FIGS. 2A and 2B, a characteristic according to a command issued by the information outputting section 106 is selected. In the characteristic shown in FIG. 2A, an angle with the largest received power observed by the feed characteristic changing section 103 with the arriving direction of the wave signal taken as a reference is selected. In the characteristic shown in FIG. 2B, on the other hand, an angle with a received power attenuated by 10 dB from the largest received power observed by the feed characteristic changing section 103 with the arriving direction of the wave signal taken as a reference is selected.

When the orientation of the characteristic exhibited by the feed characteristic changing section 103 is changed from the one shown in FIG. 2A to the one shown in FIG. 2B in accordance with a command issued by the information outputting section 106, a difference of 10 dB is generated in the power of the unmodulated wave signal fed by the feed characteristic changing section 103 to the reflected wave modulation section 105.

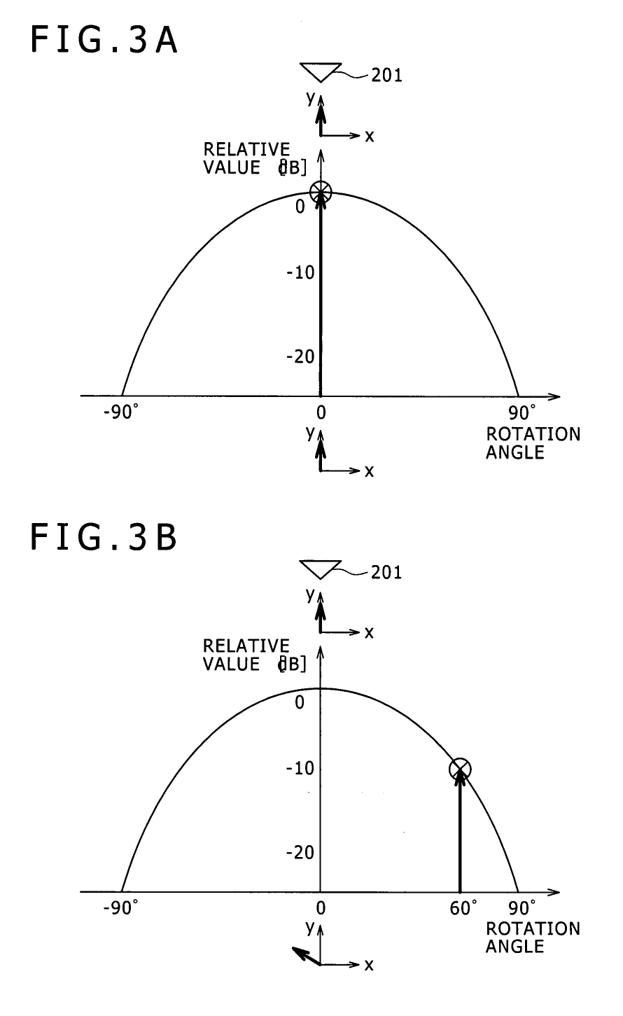

FIGS. 3A and 3B are diagrams each showing another characteristic exhibited by the feed characteristic changing section 103. The other characteristic represents received power-changes caused by variations of the polarization direction of the receiving antenna 101. The horizontal axis represents the rotation angle formed by the polarization direction of the receiving antenna 101 with respect to the polarization direction of the arriving wave signal. On the other hand, the vertical axis represents the received power observed by the feed characteristic changing section 103. Strictly speaking, the vertical axis represents the relative value of the received power with the received power at a rotation angle of zero degree taken as a reference. The rotation angle of zero degree indicates that the polarization direction of the receiving antenna 101 matches the polarization direction of the arriving wave signal. As described above, the received power at a rotation angle of zero degree is taken as a reference, which has a value of 0 dB in the scale of the vertical axis. As is obvious from the characteristic, the closer the rotation angle between the polarization directions to zero degree, the larger the relative value of the received power. That is to say, the closer the rotation angle between the polarization directions to 90 degrees, the smaller the relative value of the received power. It is to be noted that, in the case of the curves shown in FIG. 3, the characteristics of the wave signal and the antenna are each assumed to be a straight line polarization characteristic.

In the figure, the x coordinate axis of an xy coordinate system is an axis representing the polarization angle of the arriving wave signal. The polarization direction of 90 degrees on the x coordinate axis corresponds to an aforementioned rotation angle of zero degree whereas the polarization direction of 180 degrees on the x coordinate axis corresponds to an aforementioned rotation angle of 90 degrees. In the case of the characteristic shown in FIG. 3A, a received power at the polarization direction of 90 degrees corresponding to a rotation angle of zero degree is selected. This selected received power is the largest received power among received powers observed by the feed characteristic changing section 103 for different polarization directions of the arriving wave signal. In the case of the characteristic shown in FIG. 3B, on the other hand, a received power at the polarization direction of 150 degrees corresponding to a rotation angle of 60 degrees is selected. This selected received power is a received power attenuated by 10 dB from the largest received power among received powers observed by the feed characteristic changing section 103 for different polarization directions of the arriving wave signal.

When the polarization direction (or the rotation angle) in the characteristic exhibited by the feed characteristic changing section 103 is changed from the one shown in FIG. 3A to the one shown in FIG. 3B in accordance with a command issued by the information outputting section 106, a difference of 10 dB is generated in the power of the unmodulated wave signal fed by the feed characteristic changing section 103 to the reflected wave modulation section 105. It is to be noted that, while a straight line polarization signal is assumed in the above description, the same characteristic is obtained for an apparatus processing an elliptical polarization signal.

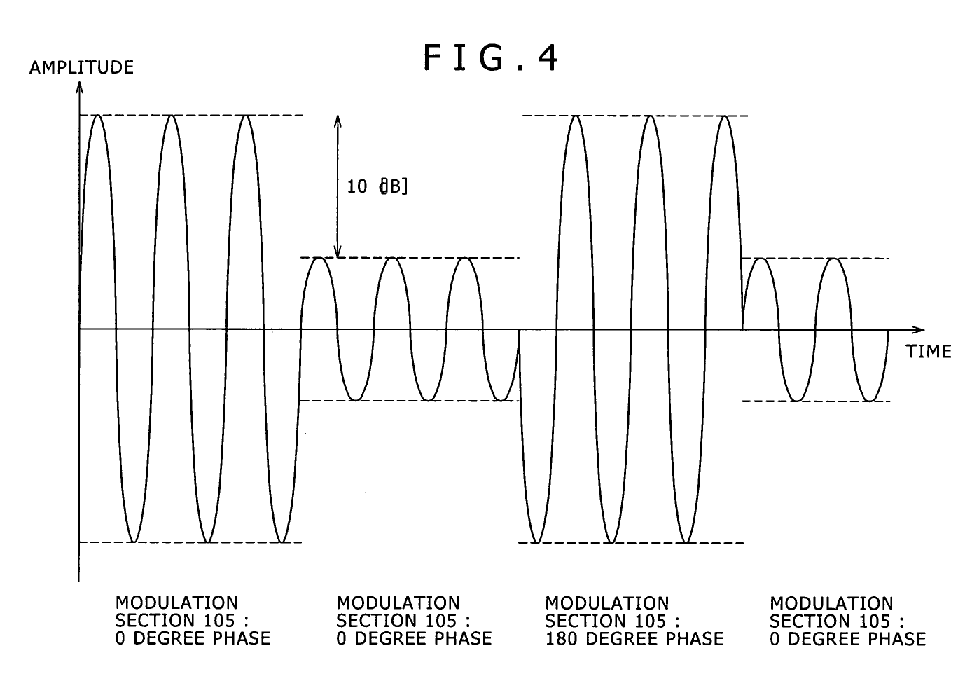

FIG. 4 is a diagram showing an output generated by the reflected wave modulation section 105 on the basis of FIGS. 2A, 2B, 3A, and 3B. In the figure, the horizontal axis is the time axis whereas the vertical axis represents the amplitude of the output generated by the reflected wave modulation section 105. Thus, FIG. 4 shows changes observed in the amplitude of the output generated by the reflected wave modulation section 105 with the lapse of time.

In this case, information supplied by the information outputting section 106 to the reflected wave modulation section 105 is assumed to be “0010” where the zero bit represents a zero degree phase whereas the one bit represents a 180 degree phase. The command issued by the information outputting section 106 to the feed characteristic changing section 103 causes the change from the characteristic shown in FIG. 2A to the characteristic shown in FIG. 2B or the change from the characteristic shown in FIG. 3A to the characteristic shown in FIG. 3B. It is to be noted that the information supplied by the information outputting section 106 to the reflected wave modulation section 105 is synchronized with the command issued by the information outputting section 106 to the feed characteristic changing section 103. In addition, the switching period of the reflected wave modulation section 105 and the feed characteristic changing section 103 is made equal to a multiple of the period of the wave signal in order to make the diagram of FIG. 4 easy to view. In actuality, however, the switching period does not have to be a multiple of the period of the wave signal.

As described above, when the orientation of the characteristic exhibited by the feed characteristic changing section 103 is changed from the one shown in FIG. 2A to the one shown in FIG. 2B or when the polarization direction (or the rotation angle) in the characteristic exhibited by the feed characteristic changing section 103 is changed from the one shown in FIG. 3A to the one shown in FIG. 3B, a difference of 10 dB is generated in the power of the unmodulated wave signal fed by the feed characteristic changing section 103 to the reflected wave modulation section 105. Thus, the orientation change from the characteristic shown in FIG. 2A to the characteristic shown in FIG. 2B or the polarization direction (or rotation angle) change from the characteristic shown in FIG. 3A to the characteristic shown in FIG. 3B causes a difference of 10 dB to be generated in a modulated reflected wave signal obtained as a result of a process carried out by the reflected wave modulation section 105 to modulate an unmodulated wave signal.

Then, the output of the reflected wave modulation section 105 is transmitted to the reflected wave reading apparatus 200 to be received by the demodulation section 205 of the reflected wave reading apparatus 200 by way of the radiation characteristic changing section 104, the transmitting antenna 102 and the receiving antenna 202. The demodulation section 205 observes the difference of 10 dB between the characteristic shown in FIG. 2A (or 3A) and the characteristic shown in FIG. 2B (or 3B). It is to be noted that the information supplied by the information outputting section 106 to the reflected wave modulation section 105 can be controlled independently of the received power selected by the feed characteristic changing section 103 as the power of the arriving unmodulated wave signal.

By the same token, the radiation characteristic changing section 104 is also capable of generating a radiation power difference similar to the difference caused by the feed characteristic changing section 103 as the difference in received power between the characteristics shown in FIGS. 2A (or 3A) and 2B (or 3B). The difference generated by the radiation characteristic changing section 104 is then conveyed in a modulated wave signal transmitted to the receiving antenna 202 employed in the reflected wave reading apparatus 200. In this case, instead of changing the received power, the radiation characteristic changing section 104 changes the aforementioned radiation power, which is the power of a radiated modulated wave signal. In actuality, however, the power of a radiated modulated wave signal is not changed. Instead, the directivity and or polarization plane of a wave signal radiated by the transmitting antenna 102 employed in the reflected wave transmission apparatus 100 is changed in order to vary the power of the wave signal received by the receiving antenna 202 employed in the reflected wave reading apparatus 200.

It is to be noted that, as described above, the technique of controlling the polarization plane can be applied to straight line and elliptical polarization signals. In addition, if binary power control is executed, for a case in which the arriving wave signal is a straight line polarization signal, the feed characteristic changing section 103 switches the feed characteristic from that exhibited with respect to a straight line polarization signal to that exhibited with respect an elliptical polarization signal or vice versa and, for a case in which the characteristic of the receiving antenna 202 employed in the reflected wave reading apparatus 200 is a characteristic exhibited with respect to a straight line polarization signal, the radiation characteristic changing section 104 switches the radiation characteristic from that exhibited with respect to a straight line polarization signal to that exhibited with respect to an elliptical polarization signal or vice versa in order to make it possible to control the power observed by the demodulation section 205. In this case, the power control can be executed even if a circular polarization signal, which can be a right direction circular polarization signal or a left direction circular polarization signal, is fed as a selection option in addition to the options of the elliptical and straight line polarization signals. It is also needless to say that, if fine power control is required, in addition to the selection of a polarization signal, control of the angle of the directivity and the angle of the polarization plane can also be executed at the same time. As a matter of fact, any combination of the selection of a polarization signal, the control of the angle of the directivity and the control of angle of the polarization plane can be adopted if the combination results in the desired power control. As described above, the selected polarization signal can be a circular polarization signal, which can be a right direction circular polarization signal or a left direction circular polarization signal, a straight line polarization signal or an elliptical polarization signal.

In addition, as described above, the information outputting section 106 supplies a command to the feed characteristic changing section 103 or the radiation characteristic changing section 104 in order to generate a difference selected as the difference in received power between the characteristics shown in FIGS. 2A (or 3A) and 2B (or 3B). However, the difference to be generated by the information can be selected from differences not limited to the two above differences, that is, the difference in received power between the characteristics shown in FIGS. 2A and 2B and the difference in received power between the characteristics shown in FIGS. 3A and 3B. On top of that, the control of the feed characteristic changing section 103 and the radiation characteristic changing section 104 is not executed to select one of two values only but can also be executed to select one of more than two values. In addition, the angle of the directivity and the angle of the polarization plane can also be changed continuously.

In such a case, a wave signal having any radiation power can be radiated from the transmitting antenna 102 employed in the reflected wave transmission apparatus 100. If a characteristic has a plurality of values to be selected as described above, signal transmissions based on the QAM (Quadratic Amplitude Modulation) can be implemented as reflected wave transmissions. In addition, if the angle of the directivity and the angle of the polarization plane can be changed continuously, signal transmissions based on the OFDM or other methods can also be implemented as reflected wave transmissions.

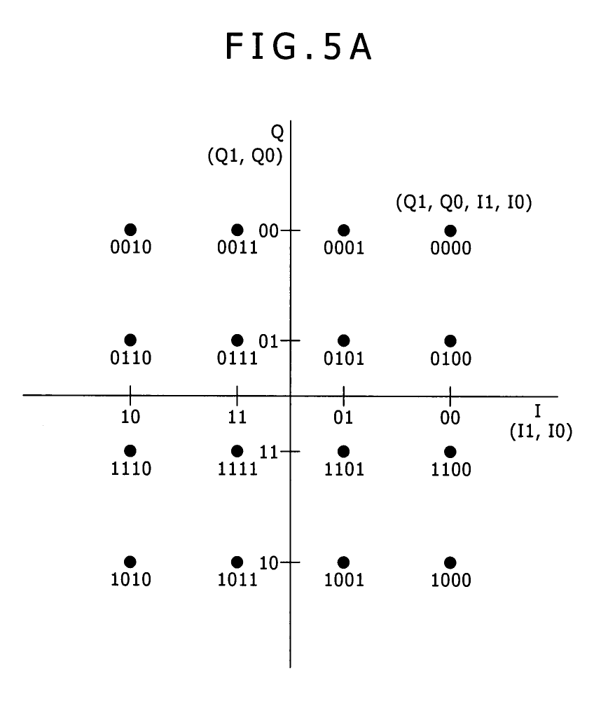

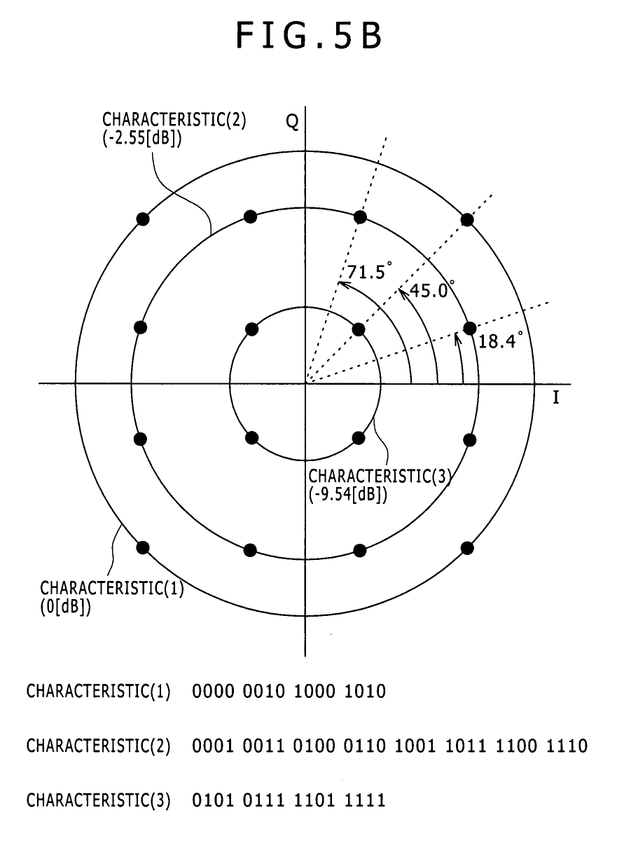

FIGS. 5A and 5B are diagrams each referred to in explaining the state of mapping bit data onto a phase space in a 16QAM method by making use of the configuration of the reflected wave transmission apparatus 100 according to the embodiment.

A constellation shown in FIG. 5A is typical mapping of bit data of the existing 16QAM method. In the embodiment, bit data is mapped onto the same signal points as those shown in FIG. 5A. FIG. 5B is a diagram showing relations between mapping points used in the embodiment and the feed characteristic changing section 103 or the radiation characteristic changing section 104. Characteristics (1), (2) and (3) shown in the figure each represent a result taking the characteristic of the feed characteristic changing section 103 or the radiation characteristic changing section 104 into consideration.

At that time, in order to transmit (0000), (0010), (1000) and (1010) at mapping points (Q1, Q0, I1, I0), an attenuation of 0 dB provided by the characteristic (1) is selected. In order to transmit (0001), (0011), (0100) and (0110), (1001), (1011), (1100) and (1110), an attenuation of −2.55 dB provided by the characteristic (2) is selected. In order to transmit (0101), (0111), (1101) and (1111), an attenuation of −9.54 dB provided by the characteristic (3) is selected. That is to say, the attenuation of a characteristic providing mapping points on the circumference of the same circle is selected.

An attenuation is computed by taking the attenuation of a characteristic providing mapping points on the circumference of a concentric circle with the largest radius as a reference of 0 dB. Then, the attenuation of any other characteristic is computed as a value relative to the reference. In FIG. 5B, the concentric circle with the largest radius is the circle for mapping points provided by the characteristic (1). The radius of this concentric circle is (3²+3²)^{1/2}. The radius of a concentric circle for mapping points provided by the characteristic (2) is (3²+1²)^{1/2}. On the other hand, the radius of a concentric circle for mapping points provided by the characteristic (3) is (1²+1²)^{1/2}. Thus, the attenuation of the characteristic (2) is 20×log((3²+1²)^{1/2}/(3²+3²)^{1/2}=−2.55 dB whereas the attenuation of the characteristic (3) is 20×log((1²+1²)^{1/2}/(3²+3²)^{1/2}=−9.54 dB.

The information outputting section 106 supplies mapping points provided by a characteristic with a desired attenuation to the feed characteristic changing section 103 or the radiation characteristic changing section 104. As an alternative the information outputting section 106 supplies a command to the feed characteristic changing section 103 or the radiation characteristic changing section 104 as a command indicating a selected one of the three characteristics shown in FIG. 5B. If the information outputting section 106 supplies mapping points provided by a characteristic with a desired attenuation to the feed characteristic changing section 103 or the radiation characteristic changing section 104, the feed characteristic changing section 103 or the radiation characteristic changing section 104 selects one of the three characteristics.

The following description explains a relation between a plurality of mapping points located on the circumference of each concentric circle shown in FIG. 5B and the information outputting section 106.

The diagram of FIG. 5B shows angles for mapping points in the first quadrant of the phase space. For example, the angle for a mapping point (0001) located on the circumference of the characteristic (2) with an attenuation of −2.55 dB is 71.5 degrees whereas the angle for a mapping point (0100) also located on the circumference of the characteristic (2) is 18.4 degrees. This difference in angle is used as a basis for the modulation process carried out by the reflected wave modulation section 105.

To put it in detail, if the command issued by the information outputting section 106 to the reflected wave modulation section 105 is a command to select the attenuation of a characteristic providing the mapping point (0001), the reflected wave modulation section 105 105 generates a modulated wave signal having a phase of 71.5 degrees relative to a reference phase. If the command issued by the information outputting section 106 to the reflected wave modulation section 105 105 is a command to select the attenuation of a characteristic providing the mapping point (0100), on the other hand, the reflected wave modulation section 105 generates a modulated wave signal having a phase of 18.4 degrees relative to the reference phase. At this time, the command issued by the information outputting section 106 may be a mapping point itself or the information of the phase corresponding to each mapping point.

In accordance with a typical method adopted by the reflected wave modulation section 105 to provide each modulated wave signal with a phase, an unmodulated wave signal fed by the feed characteristic changing section 103 to the reflected wave modulation section 105 is used as it is and the phase of the unmodulated wave signal is merely shifted. In accordance with another typical method, the unmodulated wave signal can have only a phase shift of zero or 180 degrees. In this case, a signal for switching the phase from one of two values to the other indicates the desired phase. For example, the phase switching signal has values of 0 and 1 corresponding to the phases of zero and 180 degrees respectively. The reflected wave modulation section 105 provides a modulated wave signal with a phase relative to the reference phase in accordance with the phase switching signal.

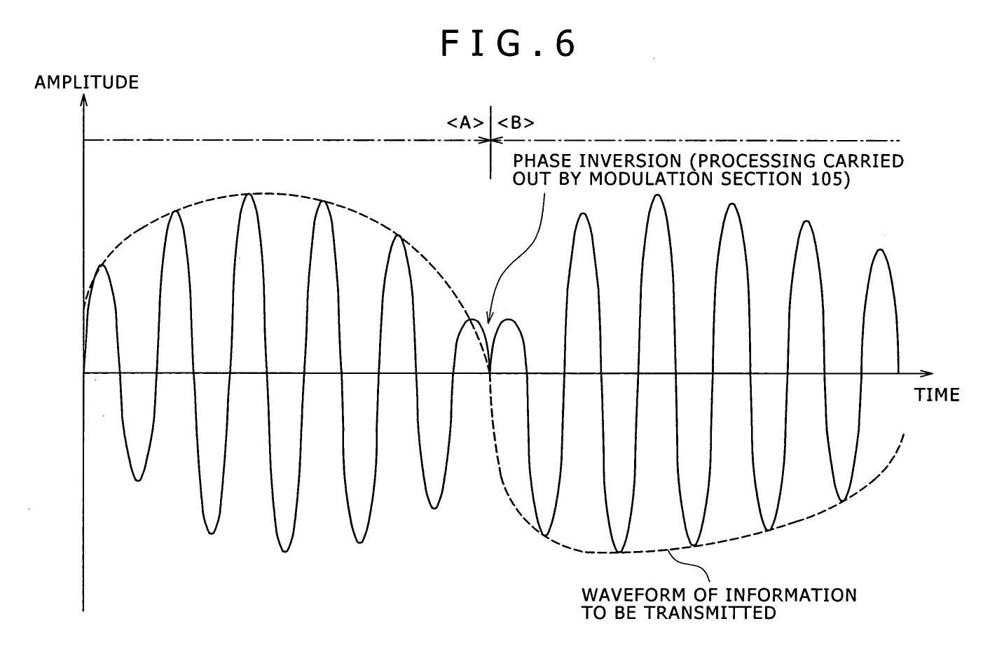

FIG. 6 is a diagram showing a typical output generated by the radiation characteristic changing section 104. As shown in the figure, the amplitude of the typical output has a null point at one time. The horizontal axis is the time axis whereas the vertical axis represents the amplitude of the output. Thus, the curve shown in the figure represents changes observed in the amplitude of the output generated by the radiation characteristic changing section 104 with the lapse of time.

In an area A shown in the figure, information supplied by the information outputting section 106 to the reflected wave modulation section 105 has a value of 0 indicating a phase of zero degree. In an area B shown in the same figure, on the other hand, information supplied by the information outputting section 106 to the reflected wave modulation section 105 has a value of 1 indicating a phase of 180 degrees. A command issued by the information outputting section 106 to the feed characteristic changing section 103 or the radiation characteristic changing section 104 is a command changed to vary the amplitude level of “the waveform of the information to be transmitted” to the reflected wave reading apparatus 200 as shown by a dashed line.

In this case, the amplitude level of “the waveform of the information to be transmitted” to the reflected wave reading apparatus 200 is an absolute value given as a command to the feed characteristic changing section 103 or the radiation characteristic changing section 104. Information indicating inversion of the sign of “the waveform of the information to be transmitted” to the reflected wave reading apparatus 200 is expressed for example by making use of the value of 0 given to the information supplied by the information outputting section 106 to the reflected wave modulation section 105 to express a phase of zero degrees and making use of the value of 1 given to the information supplied by the information outputting section 106 to the reflected wave modulation section 105 to express a phase of 180 degrees.

In the typical output shown in FIG. 6, in the vicinity of the center of the time axis, the sign of “the waveform of the information to be transmitted” to the reflected wave reading apparatus 200 is inverted. Thus, the existence of a null point may be required for the reflected wave reading apparatus 200 in some cases as a resultant characteristic of the feed characteristic changing section 103 or the radiation characteristic changing section 104. The null point seen by the reflected wave reading apparatus 200 is a state in which a signal received by the reflected wave reading apparatus 200 has a level of 0. In addition, with a timing coinciding with the null point, the reflected wave modulation section 105 carries out a process to invert the modulated wave signal.

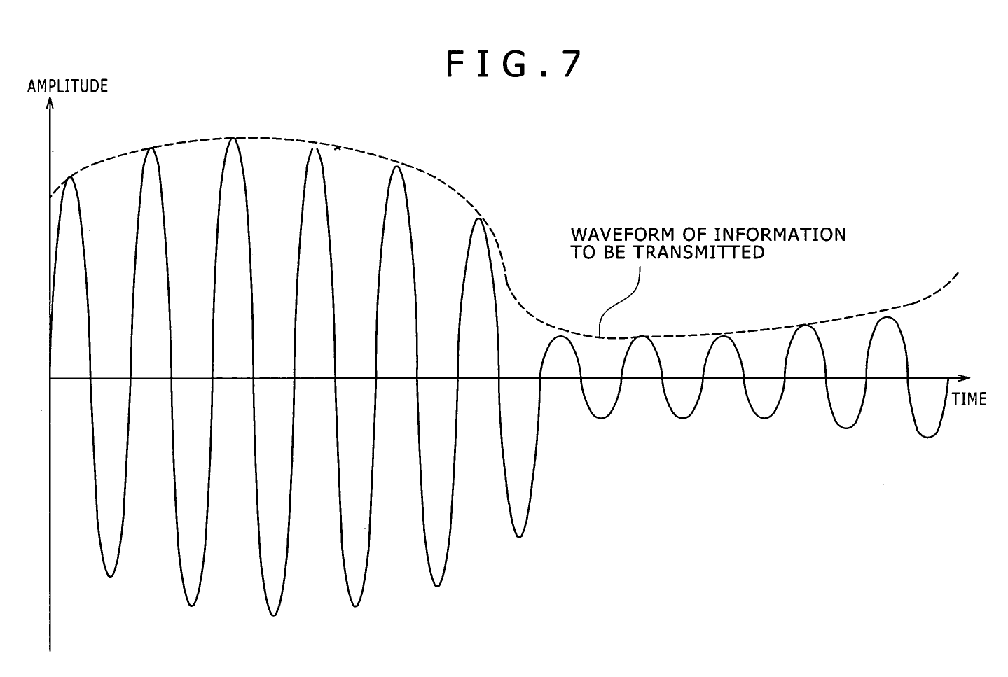

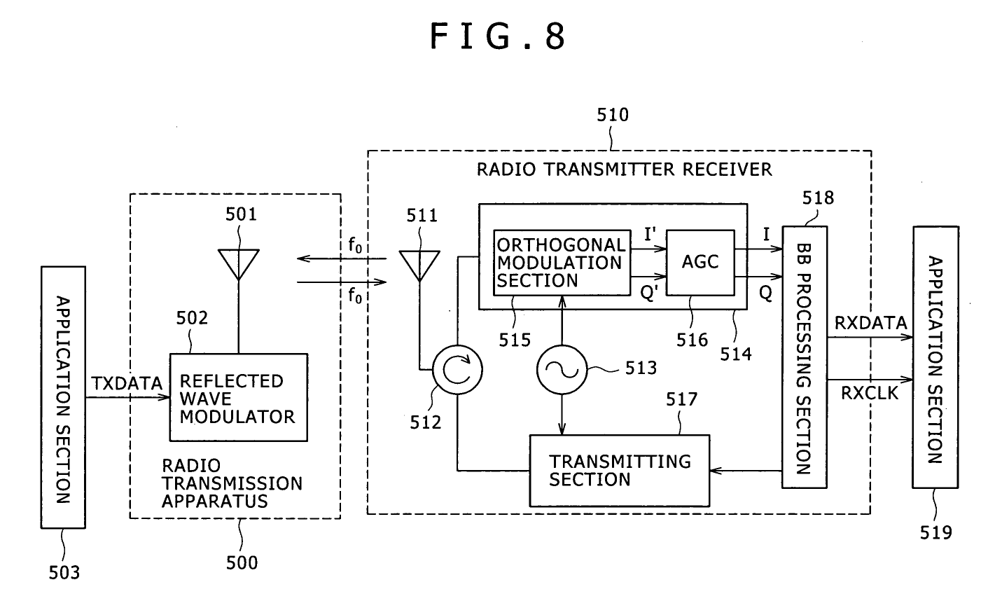

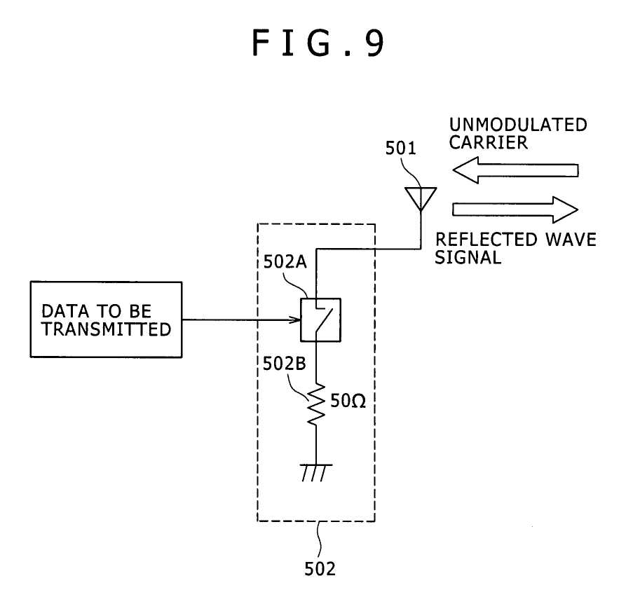

FIG. 7 is a diagram showing a typical output generated by the radiation characteristic changing section 104 as an output having no null point in either the feed characteristic or the radiation characteristic.

The horizontal axis is the time axis whereas the vertical axis represents the amplitude of the output. Thus, the curve shown in the figure represents changes observed in the amplitude of the output generated by the radiation characteristic changing section 104 with the lapse of time. Strictly speaking, the statement saying: “an output generated by the radiation characteristic changing section 104 as an output having no null point in either the feed characteristic or the radiation characteristic” means that the feed characteristic changing section 103 and the radiation characteristic changing section 104 may not be controlled to result in a state in which a wave signal received by the reflected wave reading apparatus 200 has a level of 0.

Thus, under this condition, it may be impossible to produce the changes observed in the amplitude of the output generated by the radiation characteristic changing section 104 with the lapse of time as shown in FIG. 6. In order to deal with such a condition, the changes observed in the amplitude of the output generated by the radiation characteristic changing section 104 with the lapse of time as shown in FIG. 7 are produced.

First of all, “the waveform of information to be transmitted” to the reflected wave reading apparatus 200 is replaced with a waveform having no null point. A waveform having no null point is a waveform that does not intersect a horizontal line representing the amplitude level of 0. “The waveform of the information to be transmitted” to the reflected wave reading apparatus 200 is replaced with a waveform having no null point by for example cutting the amplitude of the waveform of the information into a half and adding a direct current offset to the half of the amplitude. It is to be noted that, even if the amplitude of the waveform of the information is cut into a half in this way, the reflected wave reading apparatus 200 is capable of obtaining the information by carrying out an inverse conversion process even though the inverse conversion process is not necessarily required. That is to say, the inverse conversion process can be replaced with an equivalent process.

Then, the information outputting section 106 issues a command to the feed characteristic changing section 103 or the radiation characteristic changing section 104 on the basis of the replaced “waveform of the information to be transmitted” to the reflected wave reading apparatus 200. In this case, the information supplied by the information outputting section 106 to the reflected wave modulation section 105 is information sustaining the phase at the same value all the time. That is to say, the information supplied by the information outputting section 106 to the reflected wave modulation section 105 is information for generating a continuous modulated wave signal having a fixed phase. In other words, the reflected wave modulation section 105 virtually does not require a modulation function for merely inverting the phase.

By the way, the reflected wave reading apparatus 200 is set to carry out a demodulation process including inverse conversion processing on the wave signal received from the reflected wave transmission apparatus 100 as a signal having the waveform shown in FIG. 7.

By referring to a specific embodiment, the present invention has been explained in detail so far. It is self evident that a person skilled in the art is capable of modifying the embodiment or creating a substitute for the embodiment within a range not deviating from the range of essentials of the present invention.

The specification describes the present invention by focusing the explanation on the embodiment implementing a radio communication system for transmitting a reflected wave signal. However, the essentials of the present invention are by no means limited to the embodiment. From a standpoint of seeing that the directivity and polarization plane characteristics are stable in the reflected wave transmission method used for carrying out short distance communications, the present invention can be well applied to the reflected wave transmission method. However, a technique like the one provided by the present invention as a technique of controlling the radiation characteristic can also be similarly applied to other communication methods not making use of a reflected wave signal and to an ordinary communication system for carrying out long distance communications provided that the directivity and the polarization characteristics of the wave signal are stable so that a desired characteristic can be obtained. In addition, changes observed in a resonance point and changes observed in impedance matching of the surroundings of an antenna inside a reflected wave transmission apparatus as changes not depending on an electric wave environment allow application of the present invention to give the same effects.

In a word, the present invention has been disclosed by explaining an embodiment in the specification, the contents of which are not to be interpreted as a limitation on the scope of the present invention. In order to determine the range of essentials of the present invention, the reader is suggested to refer to a range defined by claims attached to the specification.

It should be understood by those skilled in the art that various modifications, combinations, sub-combinations and alterations may occur depending on design requirements and other factors insofar as they are within the scope of the appended claims or the equivalents thereof.

What is claimed is:

1. A radio communication apparatus for transmitting a modulated reflected wave signal to a reflected wave reading apparatus as a signal resulting from a modulation process to modulate an unmodulated carrier, which is received from said reflected wave reading apparatus, in order to superpose information to be transmitted to said reflected wave reading apparatus on said unmodulated carrier, said radio communication apparatus comprising:
an antenna;
information outputting means configured to generate information to be transmitted to said reflected wave reading apparatus;
feed characteristic changing means configured to change a feed characteristic of said antenna in accordance with said information to be transmitted;
radiation characteristic changing means configured to change a radiation characteristic of said antenna in accordance with said information to be transmitted; and
modulation means configured to carry out said modulation process according to said information to be transmitted in a process to reflect an electric wave signal received by said antenna.

2. The radio communication apparatus according to claim 1 wherein said feed characteristic changing means changes said feed characteristic by varying either of a directivity and a polarization plane, which each represent a characteristic exhibited by said antenna with respect to a wave signal.

3. The radio communication apparatus according to claim 1 wherein said radiation characteristic changing means changes said radiation characteristic by varying either of a directivity and a polarization plane, which each represent a characteristic exhibited by said antenna with respect to a wave signal.

4. The radio communication apparatus according to claim 1 wherein said feed characteristic changing means changes said feed characteristic by varying either of an impedance and a resonance point, which each represent a characteristic exhibited by said antenna with respect to a wave signal.

5. The radio communication apparatus according to claim 1 wherein said radiation characteristic changing means changes said radiation characteristic by varying either of an impedance and a resonance point, which each represent a characteristic exhibited by said antenna with respect to a wave signal.

6. The radio communication apparatus according to claim 1 wherein said feed characteristic changing means changes said feed characteristic by varying a polarization type representing a characteristic exhibited by said antenna with respect to a wave signal where said polarization type can be a circular type (a right direction circular type or a left direction circular type), an elliptical type or a straight line type.

7. The radio communication apparatus according to claim 1 wherein said radiation characteristic changing means changes said radiation characteristic by varying a polarization type representing a characteristic exhibited by said antenna with respect to a wave signal where said polarization type can be a circular type (a right direction circular type or a left direction circular type), an elliptical type or a straight line type.

8. A radio communication apparatus for carrying out communications through a radio line, said radio communication apparatus employing:
an antenna;
information outputting means configured to generate information to be transmitted;
radiation characteristic changing means configured to change a radiation characteristic of said antenna in accordance with said information to be transmitted; and
modulation means configured to carry out a modulation process according to said information to be transmitted on a signal to be transmitted.
